(19) United States
(12) Patent Application Publication
(10) Pub. No.: US 2022/0011119 A1
(43) Pub. Date: Jan. 13, 2022

(54) GENERATING AND IMPROVING UPON AGRICULTURAL MAPS

(71) Applicant: INTERNATIONAL BUSINESS MACHINES CORPORATION, Armonk, NY (US)

(72) Inventors: Sushain Pandit, Austin, TX (US); Jitendra Singh, Noida (IN); Charles Daniel Wolfson, Austin, TX (US); Saurav Basu, Bengaluru (IN)

(21) Appl. No.: 16/924,279

(22) Filed: Jul. 9, 2020

(51) Int. Cl. G01C 21/32; G06N 20/00; G06N 7/00; A01D 42/00; A01G 25/16

(52) U.S. Cl. CPC G01C 21/32; G06N 20/00; A01G 25/16; A01D 42/00; G06N 7/005

(57) ABSTRACT

The exemplary embodiments disclose a system and method, a computer program product, and a computer system for generating an agriculture map of a region of land. The exemplary embodiments may include collecting agricultural data of one or more sub-regions of the region of land, wherein the agricultural data includes classified data and unclassified data, extracting one or more features from the collected classified agricultural data, training one or more models based on the extracted one or more features, and generating an agricultural map of the region of land based on applying the one or more models to the collected unclassified agricultural data.

### BACKGROUND

The exemplary embodiments relate generally to agricultural maps, and more particularly to generating and improving agricultural maps based on agricultural data.

Agricultural maps are used by many agricultural businesses such as commodity trading, agricultural insurance and finance, and logistics, as well as by the government for agricultural export and import policies. The generation of agricultural maps is usually done with machine learning methods and requires an abundance of field data, which is costly, time consuming, and laborious to collect. Moreover, field data collection is usually collected only a few times during a crop cycle, and it is even more challenging to collect field data when cropping patterns are heterogeneous or field sizes are small.

### SUMMARY

The exemplary embodiments disclose a system and method, a computer program product, and a computer system for generating an agriculture map of a region of land. The exemplary embodiments may include collecting agricultural data of one or more sub-regions of the region of land, wherein the agricultural data includes classified data and unclassified data, extracting one or more features from the collected classified agricultural data, training one or more models based on the extracted one or more features, and generating an agricultural map of the region of land based on applying the one or more models to the collected unclassified agricultural data.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of an agricultural map generator system 100, in accordance with the exemplary embodiments.

FIG. 2 depicts an exemplary flowchart illustrating the operations of an agricultural map generator 134 of the agricultural map generator system 100 in generating an agricultural map, in accordance with the exemplary embodiments.

FIG. 3 depicts an agricultural map of a region of land with multiple sub-regions of land, in accordance with the exemplary embodiments.

FIG. 4A depicts an exemplary block diagram illustrating a method of training a model for each sub-region, in accordance with the exemplary embodiments.

FIG. 4B depicts an exemplary block diagram illustrating a method of calculating the entropy of a prediction from a trained model, in accordance with the exemplary embodiments.

FIG. 5 depicts an exemplary chart illustrating a method of determining a threshold used in determining which sub-regions of land should have additional agricultural data collected, in accordance with the exemplary embodiments.

FIG. 6 depicts an exemplary block diagram depicting the hardware components of the agricultural map generator system 100 of FIG. 1, in accordance with the exemplary embodiments.

FIG. 7 depicts a cloud computing environment, in accordance with the exemplary embodiments.

FIG. 8 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

Agricultural maps are used by many agricultural businesses such as commodity trading, agricultural insurance and finance, and logistics, as well as by the government for agricultural export and import policies. The generation of agricultural maps is usually done with machine learning methods and requires field data, which is costly, time consuming, and laborious to collect. Moreover, field data collection is usually collected only a few times during a crop cycle, and it is even more challenging to collect field data when cropping patterns are heterogeneous or field sizes are small.

Exemplary embodiments are directed to a method, computer program product, and computer system that will generate an agricultural map. In embodiments, machine learning may be used to create models capable of determining the characteristics of one or more sub-regions of an agricultural map, while feedback loops may improve upon such models. Moreover, data from sensors, the internet, social networks, and user profiles may be utilized to improve the determination of these characteristics. In embodiments, agriculture maps may include crop cover maps, acreage maps, yield maps, planting maps, land cover maps, etc. Agricultural maps may be classified by crop distribution and may have, for example, row crop, grass hay, and pasture categorizations for subregions. Agricultural maps may alternatively or additionally be classified by land use and may have for example urban, agricultural, rangeland, forest land, water, wetlands, and barren categorizations for subregions. Various agricultural maps may be generated for the purposes of farming, raising cattle, assessing the valuation of property, etc. In general, it will be appreciated that embodiments described herein may relate to aiding in the generation of any agricultural map of any portion of land within any environment for any motivation.

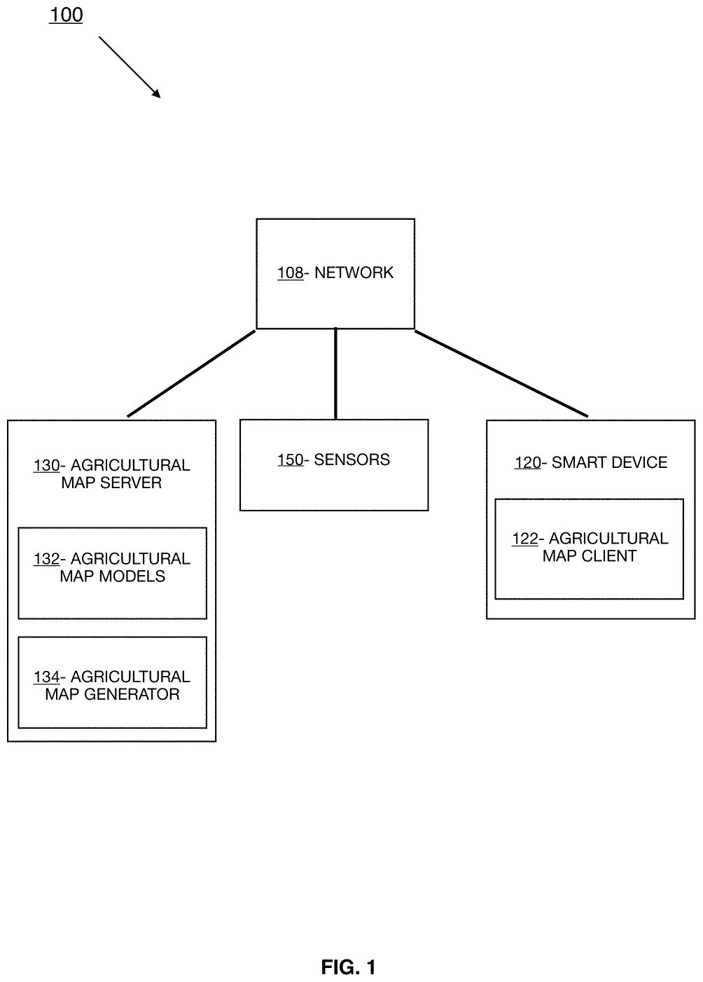

FIG. 1 depicts the agricultural map generator system 100, in accordance with the exemplary embodiments. According to the exemplary embodiments, the agricultural map generator system 100 may include a smart device 120, an agricultural map server 130, and sensors 150, which may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the agricultural map generator system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a Wi-Fi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

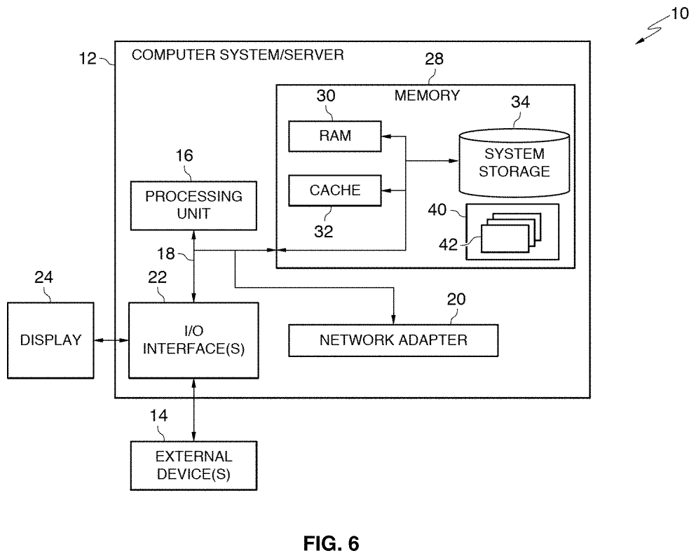

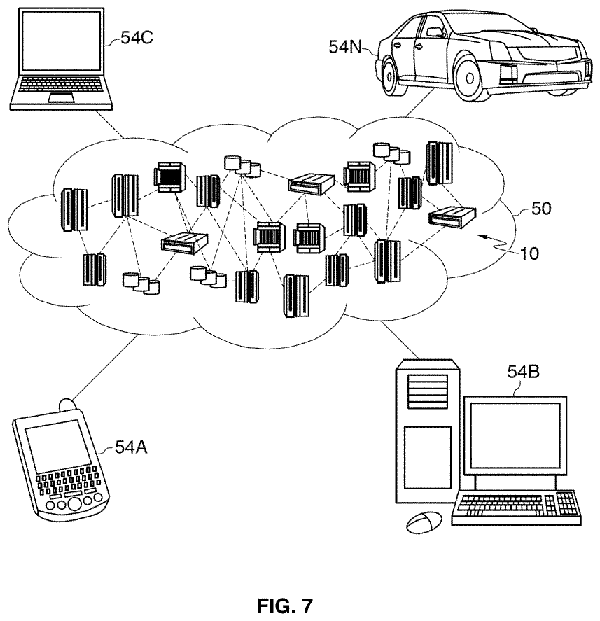

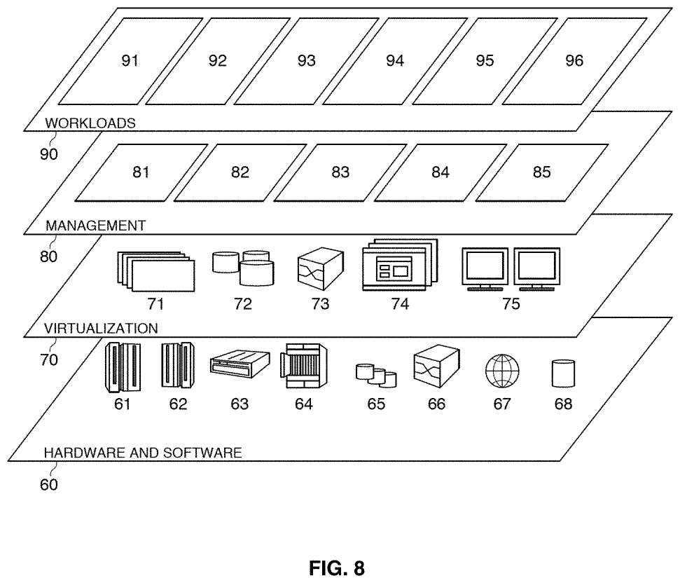

In the example embodiment, the smart device 120 includes an agricultural map client 122, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of receiving and sending data to and from other computing devices. While the smart device 120 is shown as a single device, in other embodiments, the smart device 120 may be comprised of a cluster or plurality of computing devices, in a modular manner, etc., working together or working independently. The smart device 120 is described in greater detail as a hardware implementation with reference to FIG. 6, as part of a cloud implementation with reference to FIG. 7, and/or as utilizing functional abstraction layers for processing with reference to FIG. 8.

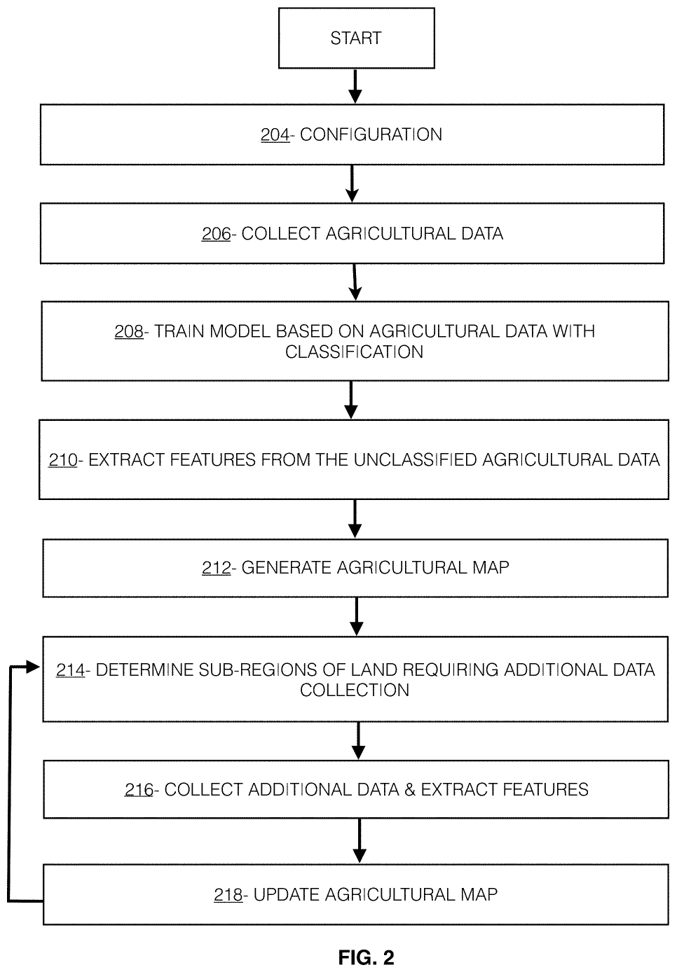

The agricultural map client 122 may be a software and/or hardware application capable of communicating with and providing a user interface for a user to interact with the agricultural map server 130 via the network 108. The agricultural map client 122 may act as a client in a client-server relationship. Moreover, in the example embodiment, the agricultural map client 122 may be capable of transferring data between the smart device 120 and other devices via the network 108. In embodiments, the agricultural map generator 134 utilizes various wired and wireless connection protocols for data transmission and exchange, including Bluetooth, 2.4 gHz and 5 gHz internet, near-field communication, Z-Wave, Zigbee, etc. The agricultural map client 122 is described in greater detail with respect to FIG. 2.

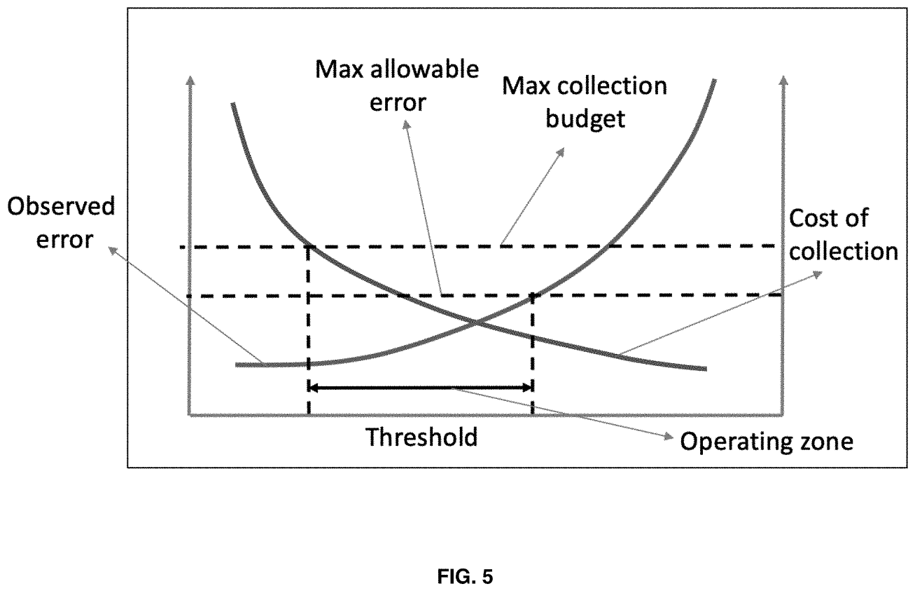

In the exemplary embodiments, the one or more sensors 150 may be a camera, radiometer, photometer, light sensor, infrared sensor, movement detection sensor, pressure sensor, moisture sensor, or other sensory hardware/software equipment, and may incorporate radar and/or light detection and ranging (LiDAR). In embodiments, the sensors 150 may be integrated with and communicate directly with smart devices such as the smart device 120, e.g., smart phones and laptops. Although the sensors 150 are depicted as integrated with smart device 120, in embodiments, the sensors 150 may be external (i.e., standalone devices) connected to the caller smart device 120 or the network 108. In embodiments, the sensors 150 may be incorporated within an environment in which the agricultural map generator system 100 is implemented. For example, in embodiments, the sensors 150 may be security cameras fastened to a light fixture in a field, video cameras fastened to devices or vehicles (land vehicles, water vehicles, aerial vehicles, etc.) traveling over a sub-region of land, moisture sensors embedded in soil, etc., and may communicate via the network 108. The sensors 150 are described in greater detail with respect to FIG. 2-5.

In the exemplary embodiments, the agricultural map server 130 includes one or more agricultural map models 132 and an agricultural map generator 134. The agricultural map server 130 may act as a server in a client-server relationship with the agricultural map client 122, and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the agricultural map server 130 is shown as a single device, in other embodiments, the agricultural map server 130 may be comprised of a cluster or plurality of computing devices, working together or working independently. The agricultural map server 130 is described in greater detail as a hardware implementation with reference to FIG. 6, as part of a cloud implementation with reference to FIG. 7, and/or as utilizing functional abstraction layers for processing with reference to FIG. 8.

The agricultural map models 132 may be one or more algorithms modelling a correlation between one or more features and a classification of a sub-region of land. The one or more features may include characteristics relating to land such as precipitation, temperature, moisture, soil type, irrigation type, crop cover, acreage, yield, crop health, sowing maps, etc., and may be detected and extracted via the one or more sensors 150 and the network 108. In embodiments, the agricultural map models 132 may weight the features based on an effect that the one or more features have on the classification of a sub-region of land. In the example embodiment, the agricultural map generator 134 may generate the agricultural map models 132 using machine learning methods, such as neural networks, deep learning, hierarchical learning, Gaussian Mixture modelling, Hidden Markov modelling, and K-Means, K-Medoids, or Fuzzy C-Means learning, etc. The agricultural map models 132 are described in greater detail with reference to FIG. 2.

The agricultural map generator 134 may be a software and/or hardware program capable of receiving a configuration of the agricultural map generator system 100. In addition, the agricultural map generator 134 may be further configured for receiving agricultural data and training a model based on the received agricultural data. Moreover, the agricultural map generator 134 may extract features from the agricultural data and apply the trained model to generate an agricultural map. The agricultural map generator 134 may be further configured for determining a sub-region of land that most requires the collection of additional agricultural data. Lastly, the agricultural map generator 134 is capable of collecting additional agricultural data for the specified sub-region of land, extracting features from the collected additional agricultural data, and updating the previously generated agricultural map. The agricultural map generator 134 is described in greater detail with reference to FIG. 2.

FIG. 2 depicts an exemplary flowchart illustrating the operations of an agricultural map generator 134 of the agricultural map generator system 100 in generating an agricultural map, in accordance with the exemplary embodiments.

The agricultural map generator 134 may receive a configuration (step 204). The agricultural map generator 134 may be configured by receiving information such as a user registration and user preferences. The user registration and user preferences may be uploaded by a user or administrator, i.e., the owner of the smart device 120 or the administrator of smart device 120. In the example embodiment, the configuration may be received by the agricultural map generator 134 via the agricultural map client 122 and the network 108, and/or may also involve receiving or extracting databases. Receiving the user registration may involve receiving information such as a name, phone number, email address, account credentials (i.e., telephone account, video-chat/web conference, etc.), company name, serial number, smart device 120 type, sensors 150 types, and the like. For example, the agricultural map generator 134 may extract spreadsheets, logs, etc. of farming history, weather history, classifications, etc. of a region of land from one or more databases. Classifications extracted from databases may be used to train one or more models.

During configuration, the agricultural map generator 134 may further receive user preferences (step 204 continued). User preferences may include a specification of a region of land to be agriculturally mapped. The agricultural map generator 134 may further receive user preferences for values of maximum allowable error and maximum collection budget. For example, a user using the agricultural map generator system 100 to determine agricultural export and import policies may specify a lower maximum allowable error value and higher maximum collection budget than a user using the agricultural map generator system 100 to determine where to build a recreational barn. In embodiments, user preferences may specify that additional agriculture data is to be collected until the maximum collection budget is reached.

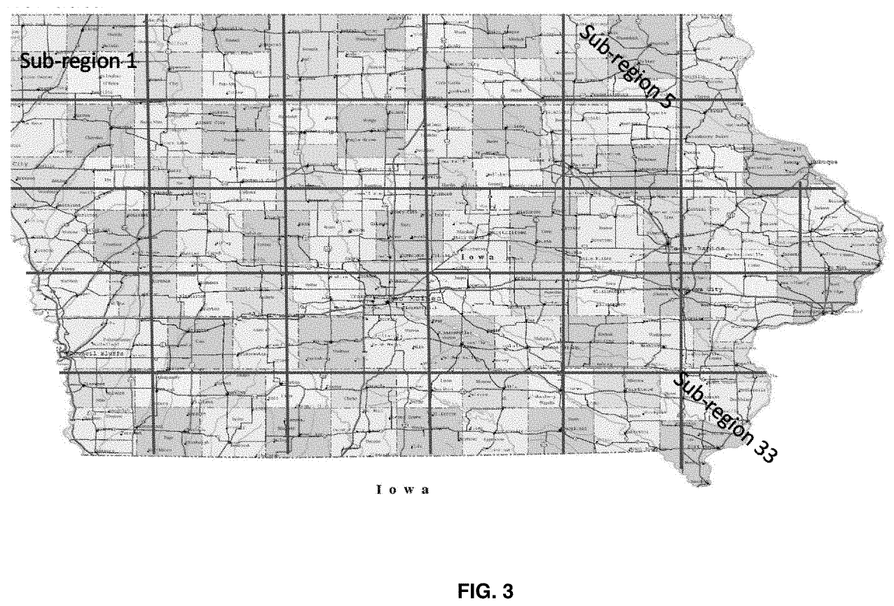

To further illustrate the operations of the agricultural map generator 134, reference is now made to an illustrative example depicted by FIG. 3 where a user uploads a user registration wherein the sensors 150 act as soil sensors and a video camera attached to a vehicle. The user also uploads user preferences including the state of Iowa broken into 33 subregions as the land to be agriculturally mapped, a maximum allowable error of 20%, a maximum collection budget of $300,000, and instructions to continue collecting additional agriculture data until the maximum collection budget is reached.

The agricultural map generator 134 may collect and/or receive agricultural data (step 206). In embodiments, agricultural data may include data pertaining to crop samples, soil samples, pest samples, crop yield, precipitation, temperature, moisture, photos/videos of land, irrigation data, sowing maps, classifications of land, etc. Agricultural data may include data such as physical access or vehicle image annotation data, remote sensing data, weather data, soil data, crop mask data, and irrigation type data. The agricultural map generator 134 may collect and/or receive agricultural data from the network 108, one or more databases uploaded or linked during user registration, and/or the sensors 150. In embodiments, the agricultural map generator 134 may collect agricultural data for the region of land to be agriculturally mapped. Collected agricultural data may include data linked or associated with one or more classifications for training purposes. In some embodiments, the agricultural map generator 134 may additionally collect training data, for example in the form of agricultural data of a labelled region of land, where a classification of land is linked or associated with one or more of a crop sample type, soil sample type, pest sample type, crop yield, crop health, precipitation, irrigation type, temperature, moisture, photo/video of land, etc.

With reference again to the previously introduced example, the agricultural map generator 134 collects weather trend data from the network 108, photos and classifications of land from databases linked during user registration and video camera sensors 150, and soil data from the soil sensors 150.

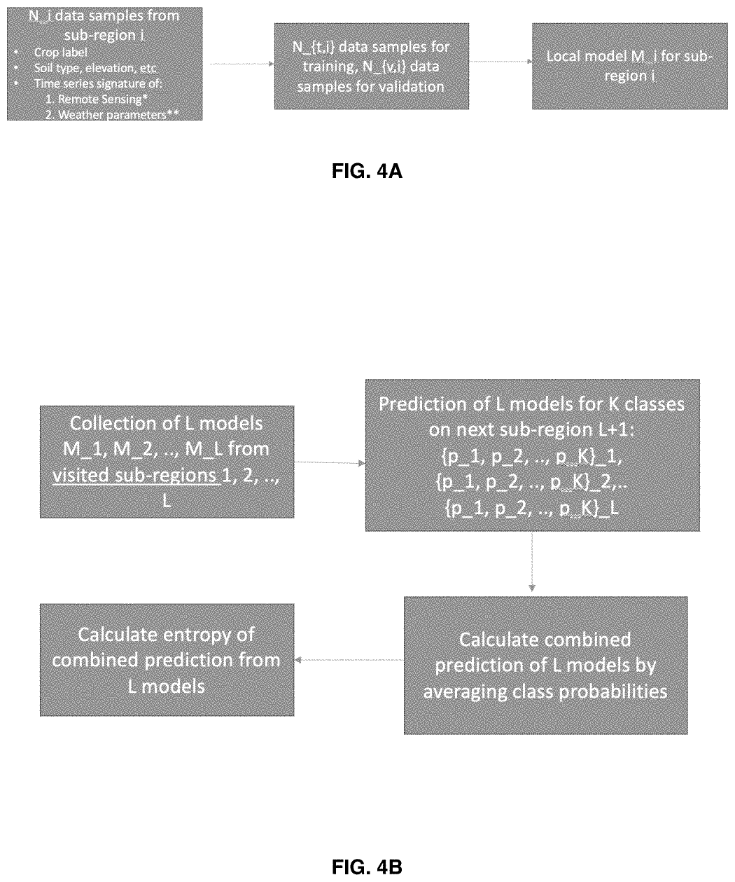

The agricultural map generator 134 may train one or more agricultural map models 132 based on the collected agricultural data linked or associated with classification (step 208). In embodiments, the agricultural map generator 134 may train one or more agricultural map models 132 based on an association between a classification of land and features associated with the land. For example, urban land may be associated with an abundance of large buildings in a photo/video of the land, which may be detected using object detection methods such as computer vision and image processing methods. Conversely, agricultural land may be associated with rich soil, low harm pests, high precipitation, high moisture, moderate temperature, and high crop yield. Lastly, barren land may be associated with poor soil, harmful pests, low precipitation, low moisture, extremely high or low temperatures, and low crop yield. Thus, the agricultural map generator 134 trains the agricultural map models 132 to capture the correlations between known classifications, for example urban, agricultural, barren, etc., and known features, for example soil, pests, precipitation, moisture, temperature, crop yield, etc. Moreover, such features may be weighted such that features more associated with a classification may count more than those that are not. Following the training process, the agricultural map models 132 may then be input features, or lack thereof, within an unclassified region from which a most likely classification may be output. With reference to FIG. 4A, the agricultural map generator 134 may in embodiments use training data and agricultural data of classified sub-regions to create a local model for each classified subregion. The agricultural map generator 134 may later use these multiple local models to classify one or more unclassified sub-regions in generating an agricultural map and/or updating an agricultural map.

With reference again to the previously introduced example where the agricultural map generator 134 collects agricultural data, the agricultural map generator 134 trains an agricultural map model 132 based on associations between the classifications urban land, agricultural land, and barren land and the features crop sample type, soil sample type, pest sample type, crop yield, crop health, irrigation type, precipitation, temperature, and photo/video object detection.

The agricultural map generator 134 may extract features from the collected and/or received unclassified agricultural data (step 210). Such features may be extracted from the data of the sensors 150, user input, and/or databases, and may include crop sample type, soil sample type, irrigation type, pest sample type, crop yield, crop health, precipitation, temperature, moisture, etc. In embodiments, features may be extracted utilizing thresholds for low or high features. For example, the agricultural map generator 134 may determine that soil samples with richness or nutrition levels above a threshold are rich soil while soil samples with richness or nutrition levels below the threshold are poor soil. Other features, such as crop yield, precipitation and temperature may be extracted as numeric values.

With reference again to the previously introduced example where the agricultural map generator 134 trains a model, the agricultural map generator 134 extracts crop sample type, soil sample type, pest sample type, crop yield, precipitation, temperature, and moisture values for sub-regions of land lacking classification.

The agricultural map generator 134 may apply the one or more agricultural map models 132 to the extracted features of unclassified sub-regions of land to generate an agricultural map (step 212). In embodiments, the agricultural map generator 134 may apply the one or more agricultural map models 132 to the extracted features to classify one or more sub-regions of land and calculate an entropy score of the classification. As previously mentioned, such extracted features may include crop sample type, soil sample type, irrigation type, pest sample type, crop yield, crop health, precipitation, temperature, moisture, etc., and the one or more agricultural map models 132 may be generated through machine learning techniques such as neural networks. The agricultural map generator 134 may then output a most likely classification of the region or subregion.

Moreover, the agricultural map generator 134 may weight the extracted features (step 212 continued). In embodiments, the one or more agricultural map models 132 may be trained at initialization and/or through the use of a feedback loop to weight the features such that features shown to have a greater correlation with the correct classification of a sub-region of land are weighted greater than those features that are not. For example, rich soil may be weighted greater than moisture in determining the suitability of land for farming. In embodiments, the agricultural map models 132 may assign a weight to each extracted feature in order to determine a classification of a sub-region of land. The agricultural map generator 134 may additionally use the agricultural map models 132 to determine an entropy score for determined classifications of sub-regions of land based on the weightings of various features. For example, the agricultural map generator 134 may determine that a classification for a sub-region of land exhibiting all features associated with that classification may have a lower entropy score than a classification for a sub-region of land exhibiting only some features associated with that classification. The agricultural map generator 134 may determine that a classification for a sub-region of land exhibiting features that are heavily weighted by the agricultural map models 132 may have a lower entropy score than a classification for a sub-region of land exhibiting features that are lightly weighted by the agricultural map models 132. The agricultural map generator 134 may express the classifications and entropy scores of sub-regions of land in the form of an agricultural map.

In embodiments, and with reference to FIG. 4B, the agricultural map generator 134 may apply multiple local models (one model for each classified sub-region) to one or more unclassified sub-regions to calculate one or more combined classification predictions for the unclassified sub-regions (step 212 continued). In embodiments, the agricultural map generator 134 may further generate classification probabilities of a sub-region for each local model, average the classification probabilities, and calculate the entropy of the average classification probability to determine an entropy score of the sub-region.

With reference again to the previously introduced example where the agricultural map generator 134 extracts crop sample type, soil sample type, pest sample type, crop yield, crop health, irrigation type, precipitation, temperature, and moisture values for sub-regions of land lacking classification, the agricultural map generator 134 determines classifications and entropy scores for each sub-region of land within Iowa, and represents them in the form of an agricultural map.

The agricultural map generator 134 may determine one or more sub-regions of land requiring more data (step 214). The agricultural map generator 134 may determine that the sub-region of land with the highest entropy score is the sub-region of land requiring more data. In embodiments, the agricultural map generator 134 may determine that all sub-regions of land with entropy scores above a maximum allowable error threshold defined during configuration require more data collection.

With reference again to the previously introduced example where the agricultural map generator 134 determines classifications and entropy scores for each sub-region of land within Iowa, and represents them in the form of an agricultural map, the agricultural map generator 134 determines that subregion 5 with entropy score 35% is the only subregion with entropy score above 20% and requires more data collection.

The agricultural map generator 134 may collect additional data and extract features from the additional data (step 216). In embodiments, the agricultural map generator 134 may collect additional data in much the same way it collects data above. Here, however, the agricultural map generator 134 may be configured to collect more of a particular type of data, collect data for a longer duration, collect data at a different time of year, etc. Moreover, the agricultural map generator 134 may be further configured to balance the additional data gathering with maximum budgetary and error considerations such that the data collection may be focused on a particular one or more features. In embodiments, the agricultural map generator 134 may initiate the collection of additional data, for example, actively collecting data from a real-time sensor, or requesting a vehicle to fly over a sub-region of land with a video camera for further surveillance.

With reference again to the previously introduced example where the agricultural map generator 134 determines that subregion 5 has the highest entropy score and requires more data collection, the agricultural map generator 134 collects additional real-time data relating to subregion 5's soil and extracts feature rich soil.

The agricultural map generator 134 may update one or more agricultural maps (step 218). The agricultural map generator 134 may update one or more agricultural maps by updating one or more classifications and/or entropy scores for one or more sub-regions of land based on the collected additional data and extracted additional one or more features. Upon updating one or more agricultural maps, in embodiments, the agricultural map generator 134 may repeat steps 214, 216, and 218 until no sub-regions of land have entropy scores indicative of requiring additional data collection and/or until the maximum collection budget detailed during configuration has been reached.

With reference again to the previously introduced example where the agricultural map generator 134 collects additional data relating to subregion 5's soil and extracts feature rich soil, the agricultural map generator 134 updates the generated agricultural map to change subregion 5's classification from barren land to agricultural land and to change subregion 5's entropy score from 35% to 12%. The agricultural map generator 134 continues determining sub-regions of land requiring additional data collection, collecting additional data, extracting features from the additional data, and updating the agricultural map until the maximum collection budget of $300,000 is reached.

FIG. 6 depicts a block diagram of devices within the agricultural map generator 134 of the agricultural map generator system 100 of FIG. 1, in accordance with the exemplary embodiments. It should be appreciated that FIG. 6 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 40 and cloud computing environment 50 can communicate with any type of computerized device over any type of network and/or network addressable connection (e.g., using a web browser).

Referring now to FIG. 8, a set of functional abstraction layers provided by cloud computing environment 50 (FIG. 7) is shown. It should be understood in advance that the components, layers, and functions shown in FIG. 8 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and agricultural map generation 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for generating an agriculture map of a region of land, the method comprising:
collecting agricultural data of one or more sub-regions of the region of land, wherein the agricultural data includes classified data and unclassified data;
extracting one or more features from the collected classified agricultural data;
training one or more models based on the extracted one or more features; and
generating an agricultural map of the region of land based on applying the one or more models to the collected unclassified agricultural data.

2. The method of claim 1, further comprising:
determining one or more entropy scores of the one or more sub-regions of land;
determining a first sub-region of land from which to collect additional data, wherein the first sub-region of land is the sub-region of land with the highest entropy score; and
collecting additional agricultural data of the first sub-region of land, wherein the collected agricultural data includes the collected additional agricultural data.

3. The method of claim 2, further comprising:
extracting one or more additional features from the collected additional agricultural data; and
updating the generated agricultural map based on the one or more additional features.

4. The method of claim 3, further comprising:
based on determining that a maximum collection budget is not yet exceeded:
determining a second sub-region of land from which to collect additional data, wherein the second sub-region of land is the sub-region of land with the second highest entropy score;
collecting additional agricultural data of the second sub-region of land;
extracting one or more additional features from the collected additional agricultural data; and
updating the generated agricultural map based on the one or more additional features.

5. The method of claim 1, wherein:
at least one model is trained for each sub-region for which the collected classified data was collected; and
the one or more trained models are applied to the one or more extracted features to calculate one or more probabilities of one or more possible classifications of the one or more sub-regions of land.

6. The method of claim 5, further comprising:
calculating one or more averages of the one or more probabilities of one or more possible classifications of the one or more sub-regions of land; and
calculating one or more entropy scores based on the one or more averages.

7. The method of claim 1, wherein:
the one or more features include features from the group comprising crop samples, soil samples, pest samples, crop yield, precipitation, temperature, moisture, photos/videos of land, and classifications of land; and
the agricultural data includes data from the group comprising physical access or vehicle image annotation data, remote sensing data, weather data, soil data, crop mask data, or irrigation type data.

8. A computer program product for generating an agriculture map of a region of land, the computer program product comprising:
one or more non-transitory computer-readable storage media and program instructions stored on the one or more non-transitory computer-readable storage media capable of performing a method, the method comprising:
collecting agricultural data of one or more sub-regions of the region of land, wherein the agricultural data includes classified data and unclassified data;
extracting one or more features from the collected classified agricultural data;
training one or more models based on the extracted one or more features; and
generating an agricultural map of the region of land based on applying the one or more models to the collected unclassified agricultural data.

9. The computer program product of claim 8, further comprising:
determining one or more entropy scores of the one or more sub-regions of land;
determining a first sub-region of land from which to collect additional data, wherein the first sub-region of land is the sub-region of land with the highest entropy score; and
collecting additional agricultural data of the first sub-region of land, wherein the collected agricultural data includes the collected additional agricultural data.

10. The computer program product of claim 9, further comprising:
extracting one or more additional features from the collected additional agricultural data; and
updating the generated agricultural map based on the one or more additional features.

11. The computer program product of claim 10, further comprising:
based on determining that a maximum collection budget is not yet exceeded:
determining a second sub-region of land from which to collect additional data, wherein the second sub-region of land is the sub-region of land with the second highest entropy score;
collecting additional agricultural data of the second sub-region of land;
extracting one or more additional features from the collected additional agricultural data; and
updating the generated agricultural map based on the one or more additional features.

12. The computer program product of claim 8, wherein:
at least one model is trained for each sub-region for which the collected classified data was collected; and
the one or more trained models are applied to the one or more extracted features to calculate one or more probabilities of one or more possible classifications of the one or more sub-regions of land.

13. The computer program product of claim 12, further comprising:
calculating one or more averages of the one or more probabilities of one or more possible classifications of the one or more sub-regions of land; and
calculating one or more entropy scores based on the one or more averages.

14. The computer program product of claim 8, wherein:
the one or more features include features from the group comprising crop samples, soil samples, pest samples, crop yield, precipitation, temperature, moisture, photos/videos of land, and classifications of land; and
the agricultural data includes data from the group comprising physical access or vehicle image annotation data, remote sensing data, weather data, soil data, crop mask data, or irrigation type data.

15. A computer system for generating an agriculture map of a region of land, the computer system comprising:
one or more computer processors, one or more computer-readable storage media, and program instructions stored on the one or more of the computer-readable storage media for execution by at least one of the one or more processors capable of performing a method, the method comprising:
collecting agricultural data of one or more sub-regions of the region of land, wherein the agricultural data includes classified data and unclassified data;
extracting one or more features from the collected classified agricultural data;
training one or more models based on the extracted one or more features; and
generating an agricultural map of the region of land based on applying the one or more models to the collected unclassified agricultural data.

16. The computer system of claim 15, further comprising:
determining one or more entropy scores of the one or more sub-regions of land;
determining a first sub-region of land from which to collect additional data, wherein the first sub-region of land is the sub-region of land with the highest entropy score; and
collecting additional agricultural data of the first sub-region of land, wherein the collected agricultural data includes the collected additional agricultural data.

17. The computer system of claim 16, further comprising:
extracting one or more additional features from the collected additional agricultural data; and
updating the generated agricultural map based on the one or more additional features.

18. The computer system of claim 17, further comprising:
based on determining that a maximum collection budget is not yet exceeded:
determining a second sub-region of land from which to collect additional data, wherein the second sub-region of land is the sub-region of land with the second highest entropy score;
collecting additional agricultural data of the second sub-region of land;
extracting one or more additional features from the collected additional agricultural data; and
updating the generated agricultural map based on the one or more additional features.

19. The computer system of claim 15, wherein:
at least one model is trained for each sub-region for which the collected classified data was collected; and
the one or more trained models are applied to the one or more extracted features to calculate one or more probabilities of one or more possible classifications of the one or more sub-regions of land.

20. The computer system of claim 19, further comprising:
calculating one or more averages of the one or more probabilities of one or more possible classifications of the one or more sub-regions of land; and
calculating one or more entropy scores based on the one or more averages.
